(19) United States
(12) Patent Application Publication
(10) Pub. No.: US 2025/0286478 A1
(43) Pub. Date: Sep. 11, 2025

(54) VIBRATIONAL ANALYSIS OF ULTRASONIC MOTORS USING QUADRATURE OSCILLATOR-ENHANCED VIBROMETRY

(71) Applicant: SEAGATE TECHNOLOGY LLC, Fremont, CA (US)

(72) Inventors: Than Zaw Myint, Shugart (SG); Xiao Lei Liao, Shugart (SG); Xiong Liu, Shugart (SG); Brendon Shi Wei Leong, Shugart (SG)

(21) Appl. No.: 18/600,968

(22) Filed: Mar. 11, 2024

(51) Int. Cl. H02N 2/10; G01H 9/00

(52) U.S. Cl. CPC H02N 2/103; G01H 9/00

(57) ABSTRACT

Described are systems and methods for vibrational analysis of ultrasonic motors. These include the use of a quadrature oscillator circuit configured to produce a dual signal output that includes two sinusoidal waves separated by a non-zero phase shift of 90 degrees or less. The ultrasonic motor is configured for simultaneous excitation of a bending mode and an expanding mode in response to the dual signal output from the quadrature oscillator. A laser doppler vibrometer is used to analyze the ultrasonic motor being operated under simultaneous bending mode and expanding mode excitation.

The disclosure relates to systems and methods for vibrational analysis of ultrasonic motors.

### SUMMARY

In accordance with certain aspects, the present disclosure describes systems and methods for vibrational analysis of ultrasonic motors. These include the use of a quadrature oscillator circuit that is configured to produce a dual signal output that includes two sinusoidal waves separated by a non-zero phase shift of 90 degrees or less. The ultrasonic motor is configured for simultaneous excitation of a bending mode and an expanding mode in response to the dual signal output from the quadrature oscillator. A laser doppler vibrometer is used to analyze the ultrasonic motor being operated under simultaneous bending mode and expanding mode excitation.

In certain aspects, the quadrature oscillator circuit is configured so that the phase shift is adjustable or so that the phase shift is fixed. In certain aspects, the phase shift is no less than 70 degrees, for example the phase shift may be 90 degrees.

In certain aspects, the quadrature oscillator circuit is configured so that the two sinusoidal waves have independently adjustable amplitudes.

In certain aspects, the quadrature oscillator circuit generates the dual signal output from a single wave sinusoidal signal generated by the control electronics of the laser doppler vibrometer. In certain aspects, one of the two sinusoidal waves of the dual signal output from the quadrature oscillator can be provided as a reference signal to the control electronics of the laser doppler vibrometer.

In accordance with certain aspects, the present disclosure describes a vibration test apparatus that includes a quadrature oscillator circuit configured to produce a dual signal output that includes two sinusoidal waves separated by a non-zero phase shift of 90 degrees or less, an ultrasonic motor communicatively coupled to the quadrature oscillator circuit and configured for simultaneous excitation of a bending mode and an expanding mode in response to the dual signal output, and a laser doppler vibrometer communicatively coupled to the quadrature oscillator circuit and configured to provide a motor drive signal for use by the quadrature oscillator circuit in producing the dual signal output, and to receive the dual signal output as a reference signal from the quadrature oscillator circuit.

In certain aspects, the ultrasonic motor comprises a piezoelectric device. In certain aspects, the piezoelectric device has a front surface and a back surface separated by a thickness, wherein the front surface includes four front triangular electrodes each having a vertex near the center of the front surface thereby forming two pairs of diagonally-opposed electrodes on the front surface, wherein the back surface includes four back triangular electrodes each having a vertex near the center of the back surface thereby forming two pairs of diagonally-opposed electrodes on the back surface, and wherein the two pairs of diagonally-opposed front electrodes are aligned through the thickness of the piezoelectric device with the two pairs of diagonally-opposed back electrodes.

In certain aspects, the electrodes of the piezoelectric devices are connected to the dual signal output of the quadrature oscillator circuit such that one of the sinusoidal waves of the dual signal output is applied across one pair of diagonally-opposed front electrodes and its aligned pair of diagonally-opposed back electrodes, and the other of the sinusoidal waves of the dual signal output is applied across the other pair of diagonally-opposed front electrodes and its aligned pair of diagonally-opposed back electrodes.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is a schematic representation of a laser doppler vibrometer test environment.

FIG. 2 is a schematic representation of a test setup for quadrature oscillator enhanced vibrational analysis of an ultrasonic motor in accordance with aspects of the present disclosure.

FIG. 3 schematically depicts the application of electrical signals to piezoelectric devices of an ultrasonic motor to excite different modes of operation.

FIG. 4 schematically represents the optical setup of a typical laser doppler test apparatus.

FIG. 5 schematically depicts the vibrations that occur in each operational mode of an ultrasonic motor, along with a graph showing the frequency response function for each operational mode.

FIG. 6 is a circuit diagram for a quadrature oscillator that may be used in accordance with the present disclosure.

### DETAILED DESCRIPTION

The present disclosure relates to the use of vibrational analysis methods, such as laser doppler vibrometry (LDV), to characterize the vibrational response of ultrasonic motors (USM). LDV can provide non-contact and non-intrusive measurements of the surface velocity and displacement of a vibrating object, for example to analyze its structural performance and integrity. When operating a USM, an excitation signal is applied to piezoelectric elements to cause the motor to vibrate at a resonance frequency, in turn generating force and motion. Certain USMs can be operated in two distinct modes of resonant vibration of the motor structure, one that is characterized as a bending mode and the other characterized as an expanding mode. The motor structure modes are derived from the structural modes of the piezoelectric elements that make up the USM. As recognized in the present disclosure, there is a need for comprehensive assessment of USMs, especially in the frequency response function of USMs under operating conditions. Current test environments and measurement methods are limited to using either the expanding mode or bending mode of the USM due to the single sinusoidal signal excitation output provided by the controller of the test apparatus.

To overcome these limitations and achieve a holistic understanding of the USM dynamic behavior, the present disclosure describes implementation of a quadrature oscillator circuit to generate two sinusoidal signals separated by a non-zero phase difference, for example a sine wave and a cosine wave having a 90 degree phase difference. The use of such a quadrature oscillator circuit enables the excitation and measurement of both expanding and bending structural modes in a USM simultaneously. This allows exploration of the full range of USM operational response, leading to more accurate and comprehensive analysis.

Quadrature oscillator circuits in accordance with the present disclosure are designed to produce two signals with a precisely maintained non-zero phase difference between them, for example a 90 degree phase difference to produce both sine and cosine signal components simultaneously. The quadrature oscillator circuit can be integrated with an LDV setup to enable concurrent measurement of the structural response of a USM operated simultaneously in expanding and bending modes, thus enabling researchers to analyze the USM's response in a way that reflects its actual usage conditions.

In accordance with the present disclosure, an LDV test machine can be enhanced by adding a quadrature oscillator circuit, thus being capable of measuring the frequency response function (FRF) of a USM under dual-mode excitation. The FRF data collected includes information from both the expanding and bending structural modes, thereby providing an enriched dataset that allows a comprehensive analysis of the USM response to provide a deeper understanding of its behavior. Analyzing a USM under simultaneous bending mode and expanding mode excitation enhances accuracy and insights while reducing testing time. There is a marked in the FRF measured when driving the USM using a quadrature oscillator circuit in accordance with the present disclosure and the FRF measured without using a quadrature oscillator circuit, since the FRF measured with a quadrature oscillator circuit represents the true FRF for motor operation configuration.

Reference will now be made to the drawings, which depict one or more aspects described in this disclosure. However, it will be understood that other aspects not depicted in the drawings fall within the scope of this disclosure. Like numbers used in the figures refer to like components, steps, and the like. However, it will be understood that the use of a reference character to refer to an element in a given figure is not intended to limit the element in another figure labeled with the same reference character. In addition, the use of different reference characters to refer to elements in different figures is not intended to indicate that the differently referenced elements cannot be the same or similar. It will also be appreciated that the drawings are meant to illustrate certain aspects and arrangements of features in a way that contributes to their understanding and are not meant to be scale drawings that accurately represent size or shape of elements. Likewise, the use of charts is meant to elucidate selected physical and optical behaviors without being bound to exactitude or to any theory.

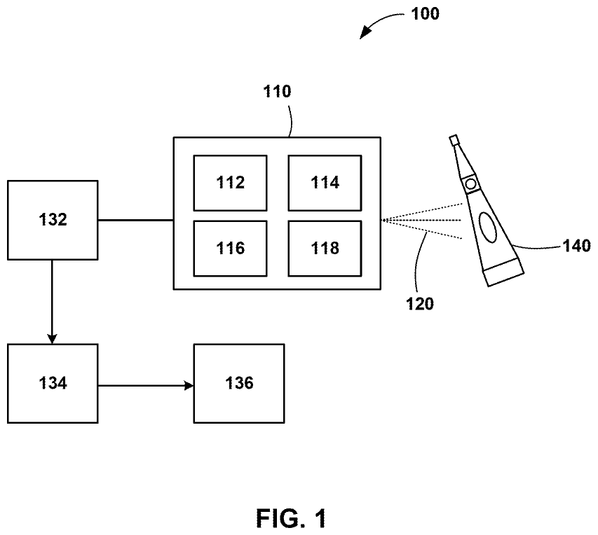

FIG. 1 shows an example of an LDV test apparatus 100 that includes a sensor head 110 coupled to control electronics 132 for controlling the various components of the sensor head 100, such as scanning electronics 112, an LDV sensor 114, LDV optics 116, and scanning mirrors 118. Other components and functions may be included in the sensor head 110 as desired. Control electronics 132 may further include or be configured for connection to other devices such as oscilloscopes or other signal monitoring devices, junction boxes, and so forth. Control electronics 132 may further be coupled to a data management system 134, which may be a computer or other data storage device capable of storing and analyzing acquired test data. A display 136 may be connected to the data management system 134 to display images and data. LDV test systems are commercially available, for example the scanning vibrometer sold under the name PSV-500 Scanning Vibrometer by Polytec GmbH.

The components of the sensor head 110 are used to scan a test object 140 with laser light 120. Light reflected from the test object is detected by components of the sensor head 110 and passed through an interferometer (not shown). In this way, the surface and structural integrity of the test object 140 can be analyzed while the test object is being vibrated, for example to simulate the vibrations that the test object would experience in an operating environment. In FIG. 1, the test object 140 is depicted as an actuator arm and suspension for a hard disk drive recording head.

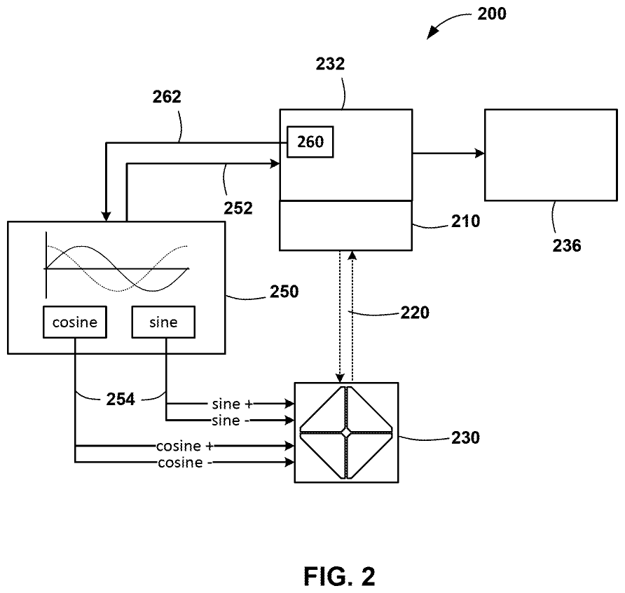

FIG. 2 is a schematic representation of a test setup 200 for vibrational analysis of an ultrasonic motor 230 that is driven using two simultaneous sinusoidal signals generated by a quadrature oscillator circuit 250. A sensor head 210 includes components for conducting laser vibrometer testing, in this case scanning an ultrasonic motor 230 with laser light 220 and receiving reflected light back for sensing and analysis, the results of which may be shown on a display 236. Sensor head 210 is coupled to control electronics 232 that includes a signal generator 260 that generates a sinusoidal signal output 262. The output 262 from signal generator 260 is input into quadrature oscillator circuit 250, which produces a dual sinusoidal wave output 254 that includes two sinusoidal waves separated by a non-zero phase shift. For example, when the phase shift is 90 degrees, the two sinusoidal waves can be represented by a sine wave and a cosine wave. Without loss of generality, the two sinusoidal waves are referred to in the present disclosure as sine and cosine. The sine wave generated by quadrature oscillator 250 can be provided back to the control electronics 232 in the form of a reference signal 252.

Ultrasonic motor 230 is configured to resonate in a bending mode and in an expanding mode depending on how the input sinusoidal signal is applied across the piezoelectric devices that make up the ultrasonic motor 230. By providing a dual sinusoidal wave signal 254 as input to the ultrasonic motor 230, the bending and expanding modes can be excited simultaneously. First, both the sine portion of the signal and the cosine portion of the signal are split into respective positive and negative inputs to the ultrasonic motor 230. These inputs are connected to the piezoelectric devices of the ultrasonic motor 230 in such a way that both the bending mode and expanding mode are excited together.

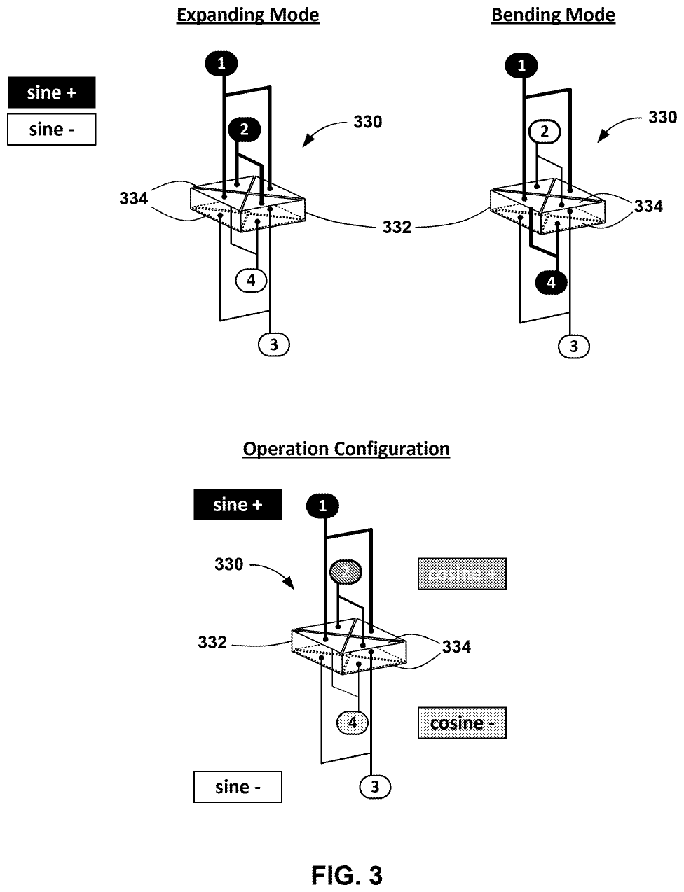

FIG. 3 schematically depicts how the application of electrical signals to piezoelectric devices of an ultrasonic motor 330 can be arranged to excite different modes of operation. Ultrasonic motor 330 includes a piezoelectric element 332 having electrodes 334 disposed on a top (front) and bottom (back) surface. In the configuration shown in FIG. 3, the electrodes 334 are triangular, each having a vertex near the center of the surface on which they are disposed, and arranged to be aligned through the thickness of the piezoelectric device 332 with a similar electrode on the opposite surface. Each of the ultrasonic motors 330 shown in FIG. 3 are identical, with the only difference being the signals applied at each electrode. As shown, the ultrasonic motor 330 is similar to the ultrasonic motor commercially available from Xeryon under the trade designation Crossfixx™, except that the piezoelectric element of the Crossfixx™ USM has a through-hole in the center of the piezoelectric element whereas piezoelectric element 332 of ultrasonic motor 330 does not include such a through-hole.

As can be seen, the eight electrode pads (four on top and four on the bottom) are arranged and connected in four sets of two diagonally-adjacent electrode pads, two sets on the top surface of piezoelectric element 332 and two on the bottom surface, each set paired together and labeled 1 through 4. The wave type and sign of the signal applied to an electrode pair is as indicated by the reference label that corresponds to the coloring of the electrode pair number. For example, a white electrode pair number on a black background, such as for electrode pair 1 in all the modes, means that a sine+ signal is applied, whereas a black number on a white background indicates a sine− signal is applied. To excite the expanding mode, a sine+ signal is applied to electrode pairs 1 and 2, and a sine− signal is applied to electrode pairs 3 and 4. To excite the bending mode, a sine+ signal is applied to electrode pairs 1 and 4, and a sine− signal is applied to electrode pairs 2 and 3. To excite both the bending and expanding modes simultaneously, which is referred to as the operation configuration, both sine and cosine signals are applied. In one example arrangement of signals, sine+ is applied to electrode 1 and sine− is applied to electrode 3, while at the same time a cosine+ signal is applied to electrode 2 and cosine− is applied to electrode 4.

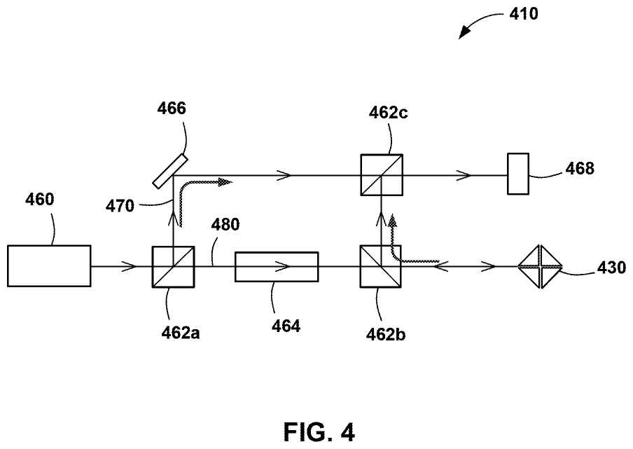

FIG. 4 schematically depicts a standard interferometer 410 such as used in laser doppler vibrometry. A laser 460 produces a beam that is split by beam splitter 462a into a target beam 480 and a reference beam 470. Target beam 480 propagates through a Bragg filter 464 and beam splitter 462b toward a test target 430, which in this case is depicted as an ultrasonic motor. Light reflected from the test target 430 is directed back into the interferometer 410 where it is reflected by beam splitter 462b toward beam splitter 462c. At the same time, reference beam 470 is reflected by mirror 466 and transmitted by beam splitter 462c, which acts as a beam recombiner, where reference beam can interfere with the light reflected off the test target and received back. The interfering beams are detected by a detector 468. Because interferometers are highly sensitive to small changes in distance traversed by the beams, minute disturbances at the surface of the test target due to vibrations can be detected based on the interference pattern received that the detector 468. For simplification of the illustration, FIG. 4 does not indicate various lenses, scanning mirrors, or other such devices as are routinely employed in laser doppler vibrometry.

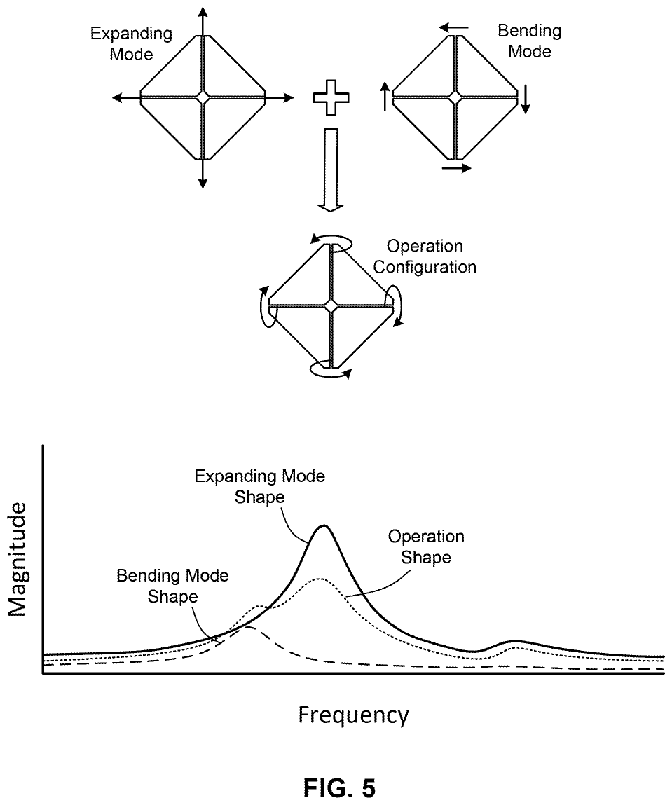

FIG. 5 illustrates the resonant motion of an ultrasonic motor under expanding mode vibration, bending mode vibration, and operating configuration vibration, which combines the expanding and bending modes. The full dynamic range of the ultrasonic motor cannot be analyzed by serially testing under separate bending mode and expanding mode excitation. This can be appreciated by comparing the frequency response functions (FRFs) of each mode, as shown in FIG. 5. It will be understood that a complete cycle of vibration occurs when the piezoelectric elements move from one extreme position to the other extreme. For example, under the expanding mode, the piezoelectric element will expand for half cycle (in the direction of the arrows shown in FIG. 5), and then contract for another half cycle (in the opposite direction). As such, the directional arrows in FIG. 5 are illustrative of an instantaneous moment in time, and are not meant to be descriptive of all motion. Moreover, in the operation configuration, the alternating expanding and contracting of the expanding mode occurs in a phase shifted manner relative to the alternating back-and-forth and up-and-down of the bending mode. The result is an elliptical motion whose direction can be changed by changing the sign of the sinusoidal signals applied to the piezoelectric elements.

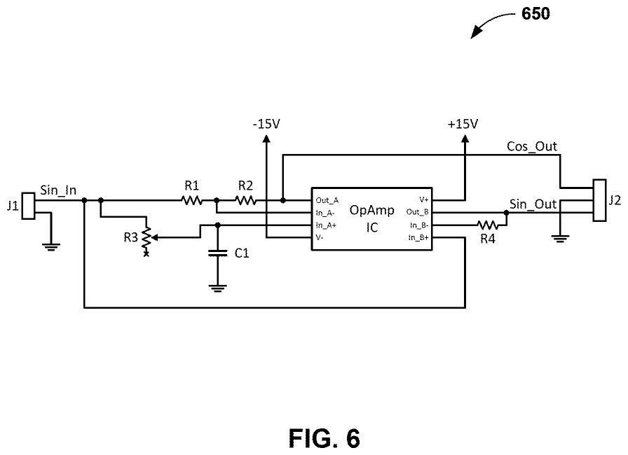

FIG. 6 is a circuit diagram of an exemplary quadrature oscillator circuit 650 in accordance with various aspects of the present disclosure. At J1, quadrature oscillator circuit 650 takes as an input a sine wave signal, denoted Sin_In. An operational amplifier chip, denoted OpAmp IC, is used to generate two sinusoidal output signals having a phase difference between them, which are produced at J2 as Cos_Out and Sin_Out. An example of a suitable operational amplifier is the LME49720 Dual High Performance, High Fidelity Audio Operational Amplifier available from Texas Instruments. As shown in FIG. 6, resistor R3 is provided at a potentiometer, which allows the phase difference between Sin_Out and Cos_Out to be adjusted. Alternatively, the phase difference can be fixed. In practice, the amplitude of the output sine and cosine signals is typical the same, although it is possible to independently adjust the signal magnitudes to achieve a different weighting of vibration contribution from the expanding mode relative to the bending mode.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules.

All scientific and technical terms used herein have meanings commonly used in the art unless otherwise specified. The definitions provided herein are to facilitate understanding of certain terms used frequently herein and are not meant to limit the scope of the present disclosure.

As used herein, the term “configured to” may be used interchangeably with the terms “adapted to” or “structured to” unless the content of this disclosure clearly dictates otherwise.

As used herein, the term “or” refers to an inclusive definition, for example, to mean “and/or” unless its context of usage clearly dictates otherwise. The term “and/or” refers to one or all of the listed elements or a combination of at least two of the listed elements.

As used herein, the phrases “at least one of” and “one or more of” followed by a list of elements refers to one or more of any of the elements listed or any combination of one or more of the elements listed.

As used herein, the terms “coupled” or “connected” refer to at least two elements being attached to each other either directly or indirectly. An indirect coupling may include one or more other elements between the at least two elements being attached. Further, in one or more embodiments, one element “on” another element may be directly or indirectly on and may include intermediate components or layers therebetween. Either term may be modified by “operatively” and “operably,” which may be used interchangeably, to describe that the coupling or connection is configured to allow the components to interact to carry out described or otherwise known functionality.

As used herein, any term related to position or orientation, such as “proximal,” “distal,” “end,” “outer,” “inner,” and the like, refers to a relative position and does not limit the absolute orientation of an embodiment unless its context of usage clearly dictates otherwise.

The singular forms “a,” “an,” and “the” encompass embodiments having plural referents unless its context clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like.

Reference to “one embodiment,” “an embodiment,” “certain embodiments,” or “some embodiments,” and so forth, means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

What is claimed is:

1. A method for vibrational analysis of an ultrasonic motor capable of resonance under a bending mode and an expanding mode, comprising the steps of:
generating a dual signal output using a quadrature oscillator circuit, the dual signal output including two sinusoidal waves separated by a non-zero phase shift of 90 degrees or less;
simultaneously exciting the bending mode and the expanding mode in the ultrasonic motor using the dual signal output; and
measuring a vibration response of the ultrasonic motor during the step of simultaneously exciting the bending mode and the expanding mode.

2. The method of claim 1, wherein the quadrature oscillator circuit is configured so that the phase shift is adjustable.

3. The method of claim 1, wherein the quadrature oscillator circuit is configured so that the phase shift is fixed.

4. The method of claim 1, wherein the phase shift is no less than 70 degrees.

5. The method of claim 1, wherein the phase shift is 90 degrees.

6. The method of claim 1, wherein the quadrature oscillator circuit is configured so that the two sinusoidal waves have independently adjustable amplitudes.

7. The method of claim 1, wherein measuring a vibration response comprises using a laser doppler vibrometer.

8. The method of claim 7, further comprising the step of receiving at the quadrature oscillator circuit a single wave sinusoidal signal from control electronics of the laser doppler vibrometer.

9. The method of claim 7, further comprising the step of providing one of the two sinusoidal waves of the dual signal output from the quadrature oscillator as a reference signal to the control electronics of the laser doppler vibrometer.

10. The method of claim 1, wherein:
the ultrasonic motor comprises a piezoelectric device having a front surface and a back surface separated by a thickness, the front surface including four front triangular electrodes each having a vertex near the center of the front surface thereby forming two pairs of diagonally-opposed electrodes on the front surface, the back surface including four back triangular electrodes each having a vertex near the center of the back surface thereby forming two pairs of diagonally-opposed electrodes on the back surface, the two pairs of diagonally-opposed front electrodes being aligned through the thickness of the piezoelectric device with the two pairs of diagonally-opposed back electrodes; and
simultaneously exciting the bending mode and the expanding mode in the ultrasonic motor using the dual signal output comprises applying one of the sinusoidal waves of the dual signal output across one of the pairs of diagonally-opposed front electrodes and its aligned pair of diagonally-opposed back electrodes, and applying the other of the sinusoidal waves of the dual signal output across the other one of the pairs of diagonally-opposed front electrodes and its aligned pair of diagonally-opposed back electrodes.

11. A vibration test apparatus comprising:
a quadrature oscillator circuit configured to produce a dual signal output that includes two sinusoidal waves separated by a non-zero phase shift of 90 degrees or less;
an ultrasonic motor communicatively coupled to the quadrature oscillator circuit and configured for simultaneous excitation of a bending mode and an expanding mode in response to the dual signal output; and
a laser doppler vibrometer communicatively coupled to the quadrature oscillator circuit and configured to provide a motor drive signal for use by the quadrature oscillator circuit in producing the dual signal output, and to receive the dual signal output as a reference signal from the quadrature oscillator circuit.

12. The vibration test apparatus of claim 11, wherein the ultrasonic motor comprises a piezoelectric device.

13. The vibration test apparatus of claim 12, wherein the piezoelectric device has a front surface and a back surface separated by a thickness, wherein the front surface includes four front triangular electrodes each having a vertex near the center of the front surface thereby forming two pairs of diagonally-opposed electrodes on the front surface, wherein the back surface includes four back triangular electrodes each having a vertex near the center of the back surface thereby forming two pairs of diagonally-opposed electrodes on the back surface, and wherein the two pairs of diagonally-opposed front electrodes are aligned through the thickness of the piezoelectric device with the two pairs of diagonally-opposed back electrodes.

14. The vibration test apparatus of claim 13, wherein the electrodes of the piezoelectric devices are connected to the dual signal output of the quadrature oscillator circuit such that one of the sinusoidal waves of the dual signal output is applied across one pair of diagonally-opposed front electrodes and its aligned pair of diagonally-opposed back electrodes, and the other of the sinusoidal waves of the dual signal output is applied across the other pair of diagonally-opposed front electrodes and its aligned pair of diagonally-opposed back electrodes.

15. The vibration test apparatus of claim 11, wherein the quadrature oscillator circuit is configured so that the phase shift is adjustable.

16. The vibration test apparatus of claim 11, wherein the quadrature oscillator circuit is configured so that the phase shift is fixed.

17. The vibration test apparatus of claim 11, wherein the quadrature oscillator circuit is configured so that the two sinusoidal waves have independently adjustable amplitudes.
